(19) United States
(12) Patent Application Publication
(10) Pub. No.: US 2025/0387999 A1
(43) Pub. Date: Dec. 25, 2025

(54) IMPACT-RESISTANT AND WAVE-ABSORBING RESIN MATRIX COMPOSITE METAMATERIAL BASED ON CHOPPED CARBON FIBER FELT AND A PREPARATION METHOD THEREOF

(71) Applicants: NORTH UNIVERSITY OF CHINA, Taiyuan (CN); SHANXI ZHONGBEI NEW MATERIAL TECHNOLOGY CO., LTD., Taiyuan (CN)

(72) Inventors: Yaqing LIU, Taiyuan (CN); Guizhe ZHAO, Taiyuan (CN); Guanyu HAN, Taiyuan (CN); Danyang LI, Taiyuan (CN)

(21) Appl. No.: 19/305,688

(22) Filed: Aug. 20, 2025

(30) Foreign Application Priority Data
Dec. 26, 2024 (CN) 202411936432.3

(51) Int. Cl. B32B 5/26; B29C 43/52; B32B 7/12; B32B 27/26; B32B 27/38; B32B 37/06

(52) U.S. Cl. CPC B32B 5/26; B29C 43/52; B32B 7/12; B32B 27/26; B32B 27/38; B32B 37/06; B32B 2250/04; B32B 2307/202; B32B 2307/204; B32B 2307/558; B32B 2307/56; B32B 2307/7376

(57) ABSTRACT

An impact-resistant and wave-absorbing resin matrix composite metamaterial based on a chopped carbon fiber felt and a preparation method thereof are provided. The composite metamaterial includes a first dielectric layer, an array structure layer, a second dielectric layer, and a reflection layer, and the first dielectric layer, the array structure layer, the second dielectric layer, and the reflection layer are laminated in sequence from top to bottom. The array structure layer has a centro-symmetric structure, and is composed of m×n carbon fiber felt structure units in a periodic arrangement. Each of the m×n carbon fiber felt structure units is a square-ring patch having an outerring width L₁ of 23-26 mm, an inner-ring width L₂ of 10-15 mm, and a periodic side length P of 30 mm.

### CROSS-REFERENCE TO RELATED APPLICATIONS

This application claims the benefit of priority from Chinese Patent Application No. 202411936432.3, filed on Dec. 26, 2024. The content of the aforementioned application, including any intervening amendments thereto, is incorporated herein by reference in its entirety.

### TECHNICAL FIELD

This application relates to resin matrix functional composites, and more particularly to an impact-resistant and wave-absorbing resin matrix composite metamaterial based on a chopped carbon fiber felt and a preparation method thereof.

### BACKGROUND

The rapid development of informatization and intelligence is accompanied by intensive use of electromagnetic waves, which further leads to a series of severe challenges, such as electromagnetic interference, electromagnetic radiation, and information security. Traditional electromagnetic wave-absorbing materials mainly rely on the loss mechanism to convert the energy of incident electromagnetic waves into thermal energy, so as to realize electromagnetic shielding or electromagnetic wave absorption. Common wave-absorbing materials include ferrites, carbon black, and conductive polymers with excellent wave absorption performance, but cannot meet the requirements of the increasingly complex application environment for electromagnetic wave absorption performance in terms of thickness, weight, and wave absorption bandwidth.

In order to further enhance the electromagnetic wave absorption performance, metamaterials have been gradually introduced into the field of wave absorption. As a type of artificial structural materials, the metamaterials can be customized in terms of physical properties (such as dielectric constant and magnetic permeability) by precisely designing structural units. In addition, the metamaterials can generate extraordinary electromagnetic responses within a specific frequency band, and exhibits a wider absorption frequency band, a smaller thickness, and a superior absorption efficiency compared with the traditional wave-absorbing materials, making them have tremendous potential in the fields of radar stealth, radio interference suppression, and wireless communication.

As an electromagnetic metamaterial, the frequency selective surface (FSS) possesses a periodic structure, which is generally composed of patterned structures made of metallic or highly-conductive materials. The electromagnetic wave reflection, transmission, and absorption characteristics of the FSS can be regulated by altering the patterns and the arrangement of the periodic structures. At present, conventional FSSs are generally designed and fabricated based on patterned metal materials. Although the resonant frequencies can be precisely adjusted through the pattern design to control electromagnetic wave characteristics, there are still problems of complex structure and high production cost. Moreover, a weak interface will be generated after the FSS is embedded in a composite, which will further lead to delamination at such interface or even failure of the whole composite.

### SUMMARY

In order to obtain a metamaterial with a wider wave absorption frequency band, a smaller thickness, and a higher absorption efficiency, and solve the problem of delamination and failure caused by introduction of the existing metamaterial into a resin matrix composite, this application provides an impact-resistant and wave-absorbing resin matrix composite metamaterial based on a chopped carbon fiber felt and a preparation method thereof.

Technical solutions of this application are described as follows.

An impact-resistant and wave-absorbing resin matrix composite metamaterial based on a chopped carbon fiber felt is provided, comprising:
a first dielectric layer;
an array structure layer;
a second dielectric layer; and
a reflection layer;
wherein the first dielectric layer, the array structure layer, the second dielectric layer, and the reflection layer are laminated in sequence from top to bottom;
the first dielectric layer, the second dielectric layer, and the reflection layer are the same as the array structure layer in terms of length and width;
the array structure layer has a centro-symmetric structure, and is composed of m×n carbon fiber felt structure units in a periodic arrangement, wherein m and n are each an integer equal to or larger than 4; the chopped carbon fiber felt of the m×n carbon fiber felt structure units has an electrical resistivity of 0.1-0.2 Ω·cm, an electrical conductivity of 5-10 S/cm, and a sheet resistance of 3-35 Ω/sq; each of the m×n carbon fiber felt structure units is a square-ring patch having an outer-ring width L₁ of 23-26 mm, an inner-ring width L₂ of 10-15 mm, and a periodic side length P of 30 mm;
the first dielectric layer is made of a first fiber fabric-reinforced resin matrix composite; the second dielectric layer is made of a second fiber fabric-reinforced resin matrix composite; and the reflection layer is made of a third fiber fabric-reinforced resin matrix composite; and
a method for preparing the impact-resistant and wave-absorbing resin matrix composite metamaterial based on a chopped carbon fiber felt, comprising:
(S1) designing a structure of the resin matrix composite metamaterial, wherein the structure of the resin matrix composite metamaterial comprises the first dielectric layer, the array structure layer, the second dielectric layer, and the reflection layer from top to bottom;
(S2) according to a designed structure of the array structure layer, cutting the chopped carbon fiber felt into m×n square-ring patches with a designed size;
(S3) according to a length and a width of the designed structure of the array structure layer, cutting a plurality of first fiber fabrics for the first dielectric layer;
(S4) according to the length and the width of the designed structure of the array structure layer, cutting a plurality of second fiber fabrics for the second dielectric layer;
(S5) according to the length and the width of the designed structure of the array structure layer, cutting a plurality of third fiber fabrics for the reflection layer;
(S6) mixing an epoxy resin and a curing agent to obtain a resin adhesive;
cleaning a mold and applying a mold release agent onto the mold;
successively laying the plurality of third fiber fabrics in a stacked manner on a lower mold plate of the mold, and applying the resin adhesive on each of the plurality of third fiber fabrics to obtain the reflection layer with a designed thickness;
successively laying the plurality of second fiber fabrics in a stacked manner on the reflection layer, and applying the resin adhesive on each of the plurality of second fiber fabrics to form the second dielectric layer with a designed thickness;
successively placing the m×n square-ring patches on the second dielectric layer according to the structure of the array structure layer to form the array structure layer;
successively laying the plurality of first fiber fabrics in a stacked manner on the array structure layer, and applying the resin adhesive on each of the plurality of first fiber fabrics except the last one to form the first dielectric layer with a designed thickness; and
closing the mold, and transferring the mold to a pressing machine for heat-press molding to obtain the resin matrix composite metamaterial.

In an embodiment, a first fiber fabric of the first fiber fabric-reinforced resin matrix composite is selected from the group consisting of an aramid fiber fabric, a glass fiber fabric, an ultra-high molecular weight polyethylene fiber fabric, a quartz fiber fabric, and a combination thereof.

In an embodiment, a second fiber fabric of the second fiber fabric-reinforced resin matrix composite is selected from the group consisting of an aramid fiber fabric, a glass fiber fabric, an ultra-high molecular weight polyethylene fiber fabric, a quartz fiber fabric, and a combination thereof.

In an embodiment, a thickness H₁ of the first dielectric layer is 2.5-5 mm; and a thickness H₂ of the second dielectric layer is 2.5-5 mm.

In an embodiment, the first fiber fabric-reinforced resin matrix composite has a dielectric constant of 2.9-3.1 and a density of 0.6-1.25 g/cm³.

In an embodiment, the second fiber fabric-reinforced resin matrix composite has a dielectric constant of 2.9-3.1 and a density of 0.6-1.25 g/cm³.

In an embodiment, a third fiber fabric of the third fiber fabric-reinforced resin matrix composite is a carbon fiber fabric; and the reflection layer has an electrical conductivity ζ₁ of 10⁴-10⁵ S/m.

In an embodiment, the reflection layer has a thickness of 2-3 mm.

In an embodiment, a resin matrix of the first fiber fabric-reinforced resin matrix composite, the second fiber fabric-reinforced resin matrix composite, and the third fiber fabric-reinforced resin matrix composite is epoxy resin; and a curing agent of the first fiber fabric-reinforced resin matrix composite, the second fiber fabric-reinforced resin matrix composite, and the third fiber fabric-reinforced resin matrix composite is an anhydride-based curing agent.

In an embodiment, the heat-press molding is performed through steps of:
keeping the mold at 100° C. for 50 min for gelation of the resin matrix; and
heating the mold to 140° C. and curing the resin matrix at 15 MPa for 2 h. The present disclosure has the following beneficial effects.

(1) The resin matrix composite metamaterial with impact resistance and wave absorption based on the chopped carbon fiber felt of the present disclosure has good incident wave polarization and stability of large incidence angles. A miniaturization design of the carbon fiber felt structure units enables the resin matrix composite metamaterial to have an oblique incidence response at 45° in transverse electric (TE) polarization and an oblique incidence response at 60° in transverse magnetic (TM) polarization. When an incidence angle of a TM wave is 60°, the resin matrix composite metamaterial still maintains an electromagnetic wave absorption rate of 80%.

(2) The resin matrix composite metamaterial of the present disclosure can obtain good electromagnetic wave absorption performance through a loss of the carbon fiber felt without using any wave-absorbing functional particles, which effectively solves problems in preparing a structure-type wave-absorbing composite material by conventional processes and methods that easy agglomeration of wave-absorbing function particles and preparation difficulty caused by increasing viscosity of a matrix resin through adding the wave-absorbing functional particles.

(3) A FSS resistance film patch of the present disclosure, through an ohmic loss generated by an induced current on its surface and ¼ wavelength resonance formed with the dielectric layers, endows the metamaterials with excellent electromagnetic wave absorption performance, which effectively solves problems in the currently widely used metal FSS of complex structure, high manufacturing cost, weak interfaces, and overall failure caused by tendency of delamination in composite materials at interfaces.

### BRIEF DESCRIPTION OF THE DRAWINGS

Accompanying drawings herein are incorporated into the description and form a part of the description, showing embodiments conforming to this application, and illustrating the principle of this application together with the description.

In order to illustrate the technical solutions of this application or the prior art more clearly, the accompanying drawings required in the description of embodiments or the prior art will be briefly introduced below. It is obvious that the following accompanying drawings only show some embodiments of this application, and for those of ordinary skill in the art, other relevant accompanying drawings can also be obtained according to these drawings without making creative effort.

FIG. 1 is a structural diagram of a resin matrix composite metamaterial with impact resistance and wave absorption based on a chopped carbon fiber felt according to an embodiment of the present disclosure.

FIG. 2 is a structural diagram of a carbon fiber felt structure unit (square-ring patch) of an array structure layer of the resin matrix composite metamaterial according to an embodiment of the present disclosure, where P represents a periodic side length of the carbon fiber felt structure unit; L₁ represents an outer-ring width of the square-ring patch; and L₂ represents an inner-ring width of the square-ring patch.

FIG. 3 is a structural diagram of the array structure layer having 6×6 carbon fiber felt structure units according to an embodiment of the present disclosure.

FIG. 4a is a simulation result of an electromagnetic wave reflection loss (RL) of the resin matrix composite metamaterial prepared in Example 1 of the present disclosure.

FIG. 4b is a simulation result of an electromagnetic wave RL of the resin matrix composite metamaterial prepared in Example 2 of the present disclosure.

FIG. 4c is a simulation result of an electromagnetic wave RL of the resin matrix composite metamaterial prepared in Comparative example 1.

FIG. 4d is a simulation result of an electromagnetic wave RL of the resin matrix composite metamaterial prepared in Comparative example 2.

FIG. 4e is a simulation result of an electromagnetic wave RL of the resin matrix composite metamaterial prepared in Comparative example 3.

FIG. 4f is a simulation result of an electromagnetic wave RL of the resin matrix composite metamaterial prepared in Comparative example 4.

FIG. 4g is a simulation result of an electromagnetic wave RL of the resin matrix composite metamaterial prepared in Comparative example 5.

FIG. 5 is a test result of an electromagnetic wave RL of the resin matrix composite metamaterial prepared in Example 1 of the present disclosure.

FIG. 6a is a simulation result of an electromagnetic wave RL of the resin matrix composite metamaterial prepared in Example 1 of the present disclosure at an incidence angle of 0° in transverse electric (TE) polarization.

FIG. 6b is a simulation result of an electromagnetic wave RL of the resin matrix composite metamaterial prepared in Example 1 of the present disclosure at an incidence angle of 15° in TE polarization.

FIG. 6c is a simulation result of an electromagnetic wave RL of the resin matrix composite metamaterial prepared in Example 1 of the present disclosure at an incidence angle of 30° in TE polarization.

FIG. 6d is a simulation result of an electromagnetic wave RL of the resin matrix composite metamaterial prepared in Example 1 of the present disclosure at an incidence angle of 45° in TE polarization.

FIG. 6e is a simulation result of an electromagnetic wave RL of the resin matrix composite metamaterial prepared in Example 1 of the present disclosure at an incidence angle of 60° in TE polarization.

FIG. 7a is a simulation result of an electromagnetic wave RL of the resin matrix composite metamaterial prepared in Example 1 at an incidence angle of 0° in transverse magnetic (TM) polarization.

FIG. 7b is a simulation result of an electromagnetic wave RL of the resin matrix composite metamaterial prepared in Example 1 at an incidence angle of 15° in TM polarization.

FIG. 7c is a simulation result of an electromagnetic wave RL of the resin matrix composite metamaterial prepared in Example 1 at an incidence angle of 30° in TM polarization.

FIG. 7d is a simulation result of an electromagnetic wave RL of the resin matrix composite metamaterial prepared in Example 1 at an incidence angle of 45° in TM polarization.

FIG. 7e is a simulation result of an electromagnetic wave RL of the resin matrix composite metamaterial prepared in Example 1 at an incidence angle of 60° in TM polarization.

FIG. 8a is a simulation result of an electromagnetic wave RL of the resin matrix composite metamaterial prepared in Comparative example 3 at an incidence angle of 0° in TE polarization.

FIG. 8b is a simulation result of an electromagnetic wave RL of the resin matrix composite metamaterial prepared in Comparative example 3 at an incidence angle of 15° in TE polarization.

FIG. 8c is a simulation result of an electromagnetic wave RL of the resin matrix composite metamaterial prepared in Comparative example 3 at an incidence angle of 30° in TE polarization.

FIG. 8d is a simulation result of an electromagnetic wave RL of the resin matrix composite metamaterial prepared in Comparative example 3 at an incidence angle of 45° in TE polarization.

FIG. 8e is a simulation result of an electromagnetic wave RL of the resin matrix composite metamaterial prepared in Comparative example 3 at an incidence angle of 60° in TE polarization.

FIG. 9a is a simulation result of an electromagnetic wave RL of the resin matrix composite metamaterial prepared in Comparative example 4 at an incidence angle of 0° in TE polarization.

FIG. 9b is a simulation result of an electromagnetic wave RL of the resin matrix composite metamaterial prepared in Comparative example 4 at an incidence angle of 15° in TE polarization.

FIG. 9c is a simulation result of an electromagnetic wave RL of the resin matrix composite metamaterial prepared in Comparative example 4 at an incidence angle of 30° in TE polarization.

FIG. 9d is a simulation result of an electromagnetic wave RL of the resin matrix composite metamaterial prepared in Comparative example 4 at an incidence angle of 45° in TE polarization.

FIG. 9e is a simulation result of an electromagnetic wave RL of the resin matrix composite metamaterial prepared in Comparative example 4 at an incidence angle of 60° in TE polarization.

FIG. 10a is a simulation result of an electromagnetic wave RL of the resin matrix composite metamaterial prepared in Comparative example 5 at an incidence angle of 0° in TE polarization.

FIG. 10b is a simulation result of an electromagnetic wave RL of the resin matrix composite metamaterial prepared in Comparative example 5 at an incidence angle of 15° in TE polarization.

FIG. 10c is a simulation result of an electromagnetic wave RL of the resin matrix composite metamaterial prepared in Comparative example 5 at an incidence angle of 30° in TE polarization.

FIG. 10d is a simulation result of an electromagnetic wave RL of the resin matrix composite metamaterial prepared in Comparative example 5 at an incidence angle of 45° in TE polarization.

FIG. 10e is a simulation result of an electromagnetic wave RL of the resin matrix composite metamaterial prepared in Comparative example 5 at an incidence angle of 60° in TE polarization.

FIGS. 11a-b respectively show load-displacement curves of the resin matrix composite metamaterials prepared in Example 1 and Comparative example 6 under the same impact energy.

### DETAILED DESCRIPTION OF EMBODIMENTS

To make the above object, features and advantages of the present disclosure more clearly, the present disclosure will be further described below. It should be noted that embodiments and features in the embodiments without conflict can be combined.

Described below is detailed description of this application, but this application can be implemented by other ways that are not described herein. It is obvious that described herein are only some embodiments of the present disclosure, rather than all embodiments.

A resin matrix composite metamaterial with impact resistance and wave absorption based on a chopped carbon fiber felt includes a first dielectric layer, an array structure layer, a second dielectric layer, and a reflection layer, and the first dielectric layer, the array structure layer, the second dielectric layer, and the reflection layer are laminated in sequence from top to bottom.

The first dielectric layer, the second dielectric layer, and the reflection layer are the same as the array structure layer in terms of length and width.

The array structure layer has a centro-symmetric structure, which is composed of m×n carbon fiber felt structure units in a periodic arrangement, where m and n are each an integer equal to or larger than 4. The chopped carbon fiber felt of the m×n carbon fiber felt structure units has an electrical resistivity of 0.1-0.2 Ω·cm, an electrical conductivity of 5-10 S/cm, and a sheet resistance of 3-35 Ω/sq. Each of the m×n carbon fiber felt structure units is a square-ring patch having an outer-ring width L₁ of 23-26 mm, an inner-ring width L₂ of 10-15 mm, and a periodic side length P of 30 mm.

The first dielectric layer is made of a first fiber fabric-reinforced resin matrix composite. The second dielectric layer is made of a second fiber fabric-reinforced resin matrix composite. The reflection layer is made of a third fiber fabric-reinforced resin matrix composite.

A method for preparing the resin-based composite metamaterial with impact resistance and wave absorption based on the chopped carbon fiber felt includes the following steps.

(S1) A structure of the resin matrix composite metamaterial is designed, where the structure of the resin matrix composite metamaterial includes the first dielectric layer, the array structure layer, the second dielectric layer, and the reflection layer from top to bottom.

(S2) According to a designed structure of the array structure layer, the chopped carbon fiber felt is cut into m×n square-ring patches with a designed size.

(S3) According to a length and a width of the designed structure of the array structure layer, a plurality of first fiber fabrics for the first dielectric layer are cut.

(S4) According to the length and the width of the designed structure of the array structure layer, a plurality of second fiber fabrics for the second dielectric layer are cut.

(S5) According to the length and the width of the designed structure of the array structure layer, a plurality of third fiber fabrics for the reflection layer are cut.

(S6) An epoxy resin and a curing agent are mixed to obtain a resin adhesive. A mold is cleaned, and a mold release agent is applied onto the mold. The plurality of third fiber fabrics are successively laid in a stacked manner on a lower mold plate of the mold, and the resin adhesive is applied on each of the plurality of third fiber fabrics to obtain the reflection layer with a designed thickness. The plurality of second fiber fabrics are successively laid in a stacked manner on the reflection layer, and the resin adhesive is applied on each of the plurality of second fiber fabrics to form the second dielectric layer with a designed thickness. The m×n square-ring patches are successively placed on the second dielectric layer according to the structure of the array structure layer to form the array structure layer. The plurality of first fiber fabrics are successively laid in a stacked manner on the array structure layer, and the resin adhesive is applied on each of the plurality of first fiber fabrics except the last one to form the first dielectric layer with a designed thickness. The mold is closed, and the mold is transferred to a pressing machine for heat-press molding to obtain the resin matrix composite metamaterial.

In an embodiment, a first fiber fabric of the first fiber fabric-reinforced resin matrix composite is selected from the group consisting of an aramid fiber fabric, a glass fiber fabric, an ultra-high molecular weight polyethylene fiber fabric, a quartz fiber fabric, and a combination thereof.

In an embodiment, a second fiber fabric of the second fiber fabric-reinforced resin matrix composite is selected from the group consisting of an aramid fiber fabric, a glass fiber fabric, an ultra-high molecular weight polyethylene fiber fabric, a quartz fiber fabric, and a combination thereof.

In an embodiment, a thickness H₁ of the first dielectric layer is 2.5-5 mm. A thickness H₂ of the second dielectric layer is 2.5-5 mm.

In an embodiment, the first fiber fabric-reinforced resin matrix composite has a dielectric constant of 2.9-3.1 and a density of 0.6-1.25 g/cm³.

In an embodiment, the second fiber fabric-reinforced resin matrix composite has a dielectric constant of 2.9-3.1 and a density of 0.6-1.25 g/cm³.

In an embodiment, a third fiber fabric of the third fiber fabric-reinforced resin matrix composite is a carbon fiber fabric. The reflection layer has an electrical conductivity ζ₁ of 10⁴-10⁵ S/m.

In an embodiment, the reflection layer has a thickness of 2-3 mm.

In an embodiment, a resin matrix of the first fiber fabric-reinforced resin matrix composite, the second fiber fabric-reinforced resin matrix composite, and the third fiber fabric-reinforced resin matrix composite is epoxy resin. A curing agent of the first fiber fabric-reinforced resin matrix composite, the second fiber fabric-reinforced resin matrix composite, and the third fiber fabric-reinforced resin matrix composite is an anhydride-based curing agent.

In an embodiment, the heat-press molding is performed as follows. The mold is kept at 100° C. for 50 min for gelation of the resin matrix, and the mold is heated to 140° C. and kept at 140° C. and 15 MPa for 2 h for the resin matrix curing. Technical solutions are illustrated through the specific embodiments below.

In this application, electromagnetic simulation is performed through microwave and radio frequency simulation software CST microwave studio 2021.

According to a GJB 2038A-2011 Measurement Method for Reflectivity of Radar Absorbing Materials, reflection loss (RL) is measured through an arch method. An impact performance test is performed according to an ASTM D 7136 Standard Test Method for Measuring the Damage Resistance of a Fiber-Reinforced Polymer Matrix Composite to a Drop-Weight Impact Event.

### Example 1

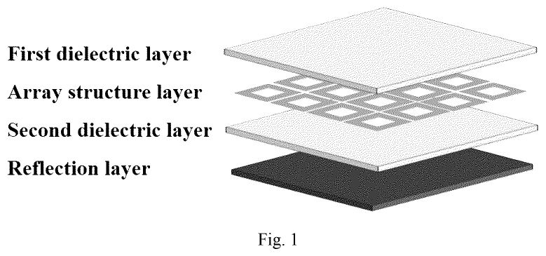

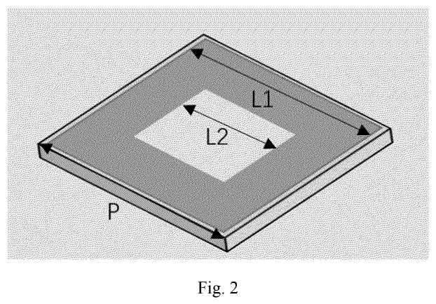

A structure of a resin matrix composite metamaterial is designed by using a CST microwave studio 2021. Referring to FIG. 1, a resin matrix composite metamaterial with impact resistance and wave absorption based on a chopped carbon fiber felt includes a first dielectric layer, an array structure layer, a second dielectric layer, and a reflection layer, and the first dielectric layer, the array structure layer, the second dielectric layer, and the reflection layer are laminated in sequence from top to bottom, and an incidence direction of an electromagnetic wave is also from top to bottom.

The first dielectric layer is made of an aramid fiber fabric-reinforced resin matrix composite, having a dielectric constant of 3, a density of 1.25 g/cm³, a thickness H₁ of 3 mm, a length of 180 mm, and a width of 180 mm.

The second dielectric layer is also made of the aramid fiber fabric-reinforced resin matrix composite, having a dielectric constant of 3, a density of 1.25 g/cm³, a thickness H₂ of 3 mm, a length of 180 mm and a width of 180 mm.

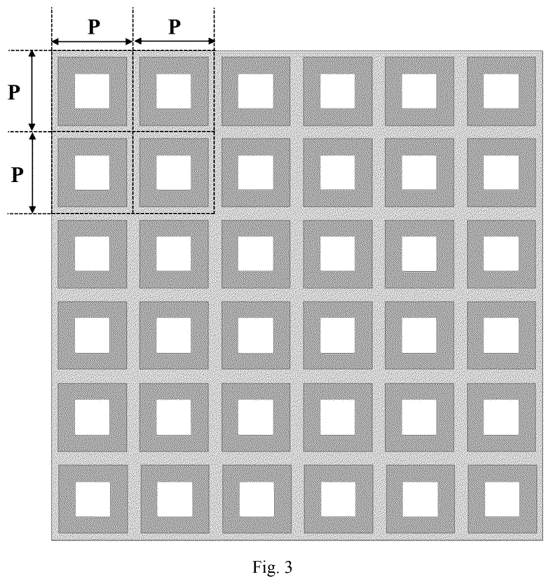

The array structure layer is composed of 6×6 carbon fiber felt structure units in a periodic arrangement. FIG. 2 shows the 6×6 carbon fiber felt structure units and FIG. 3 shows the periodic arrangement. A carbon fiber felt of the carbon fiber felt structure units has an electrical resistivity of 0.18 Ω·cm, an electrical conductivity of 5.55 S/cm, and a sheet resistance of 35 Ω/sq. Each of the 6×6 carbon fiber felt structure units has a periodic side length P of 30 mm, an outer-ring width L₁ of 25 mm, and an inner-ring width L₂ of 12.5 mm.

The reflection layer is made of a carbon fiber fabric-reinforced resin matrix composite, having an electrical conductivity ζ₁ of 5.9×10⁴ S/m, a thickness of 2 mm, a length of 180 mm, and a width of 180 mm.

The resin matrix composite metamaterial with impact resistance and wave absorption based on a chopped carbon fiber felt is prepared as follows.

(S1) A plurality of aramid fiber fabrics of the first dielectric layer and a plurality of aramid fiber fabrics of the second dielectric layer are cut according to the length of 180 mm and the width of 180 mm.

(S2) A plurality of carbon fiber fabrics of the reflection layer are cut according to the length of 180 mm and the width of 180 mm.

(S3) A carbon fiber felt is cut into 6×6 square-ring patches with a designed size according to a designed structure of the array structure layer.

(S4) Epoxy resin E51 and a curing agent cis-hexahydrophthalic anhydride are evenly mixed in a weight ratio of 1:0.8, followed by vacuum defoaming at 80° C. for 30 min to obtain a resin adhesive. A mold is cleaned, and a mold release agent is applied onto the mold. The carbon fiber fabrics are successively laid in a stacked manner on a lower mold plate of the mold, and the resin adhesive is applied on each of the plurality of carbon fiber fabrics to obtain the reflection layer, where a number of the plurality of carbon fiber fabrics is 4. The plurality of aramid fiber fabrics of the second dielectric layer are successively laid in a stacked manner on the reflection layer, and the resin adhesive is applied on each of the plurality of aramid fiber fabrics to form the second dielectric layer, where a number of the plurality of aramid fiber fabrics is 15. The 6×6 square-ring patches are successively placed on the second dielectric layer according to the structure of the array structure layer to form the array structure layer. The plurality of aramid fiber fabrics of the first dielectric layer are successively laid in a stacked manner on the reflection layer, and the resin adhesive is applied on each of the plurality of aramid fiber fabrics except the last one to form the first dielectric layer, where a number of the plurality of aramid fiber fabrics is 15. The mold is closed, and the mold is transferred to a pressing machine for heat-press molding, followed by cooling and demolding to obtain the resin matrix composite metamaterial with a thickness of 8 mm, where the heat-press molding is performed as follows: the mold is kept at 100° C. for 50 min for gelation of the resin matrix, the mold is heated to 140° C., and the resin matrix is cured at 15 MPa for 2 h.

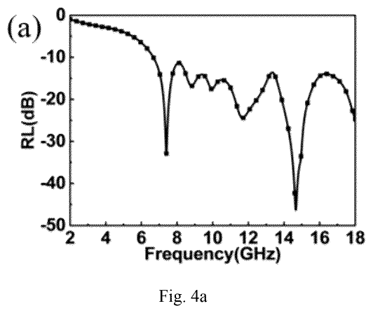

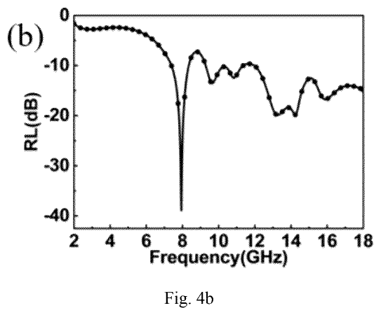

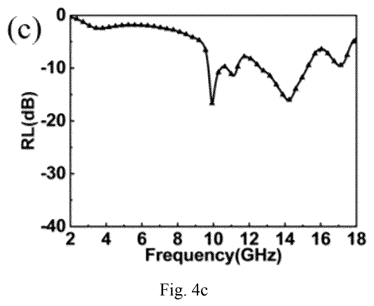

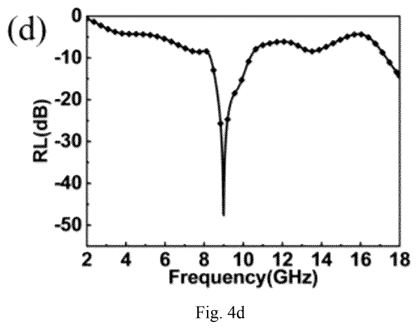

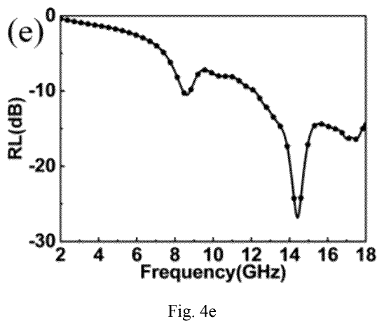

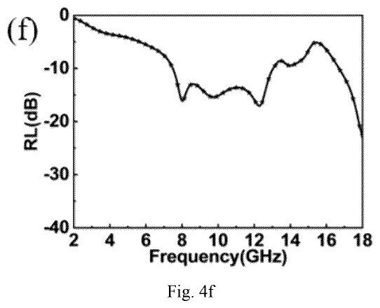

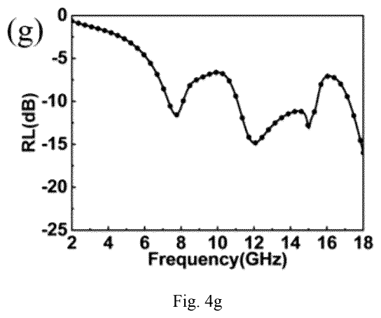

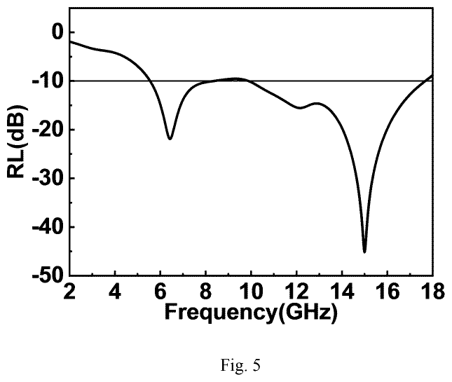

Referring to FIG. 4a and FIG. 5, the resin matrix composite metamaterial prepared in this embodiment has an effective absorbing bandwidth of 10.6 GHz with RL≤−10 dB, specially 5.5-8.3 GHz and 9.8-17.6 GHz, and a minimum RL (RLₘᵢₙ) of −45 dB. A high consistency of the results for these electromagnetic wave absorption performance indicators obtained from FIG. 4a and FIG. 5 also indicates the high reliability of the simulation results presented in the present disclosure.

### Example 2

This embodiment is the same as Example 1, except that a carbon fiber felt of the carbon fiber felt structure units has a sheet resistance of 20 Ω/sq.

Referring to FIG. 4b, the resin matrix composite metamaterial prepared in this embodiment has a RLₘᵢₙ of −38.90 dB at 7.28 GHz, and an effective absorbing bandwidth of 9.76 GHz with RL≤−10 dB within 2-18 GHz.

### Comparative Example 1

This embodiment is the same as Example 1, except the following parameters.

The first dielectric layer has a thickness H₁ of 2.5 mm, and the second dielectric layer has a thickness H₂ of 2.5 mm. A carbon fiber felt of the carbon fiber felt structure units has a sheet resistance of 15 Ω/sq. Each of the carbon fiber felt structure units has an outer-ring width L₁ of 20 mm and an inner-ring width L₂ of 10 mm.

Referring to FIG. 4c, the resin matrix composite metamaterial prepared in this embodiment has a RLₘᵢₙ of −16.70 dB at 8.78 GHz, and an effective absorbing bandwidth of 3.39 GHz with RL≤−10 dB within 2-18 GHz.

### Comparative Example 2

This embodiment is the same as Example 1, except the following parameters.

The first dielectric layer has a thickness H₁ of 3.5 mm, and the second dielectric layer has a thickness H₂ of 3.5 mm. A carbon fiber felt of the carbon fiber felt structure units has a sheet resistance of 25 Ω/sq. Each of the carbon fiber felt structure units has an outer-ring width L₁ of 20 mm and an inner-ring width L₂ of 10 mm.

Referring to FIG. 4d, the resin matrix composite metamaterial prepared in this embodiment has a RLₘᵢₙ of −47.66 dB at 8.22 GHz, and an effective absorbing bandwidth of 4.18 GHz with RL≤−10 dB within 2-18 GHz.

### Comparative Example 3

This embodiment is the same as Example 1, except that the first dielectric layer has a thickness H₁ of 2 mm, and the second dielectric layer has a thickness H₂ of 2 mm.

Referring to FIG. 4e, the resin matrix composite metamaterial prepared in this embodiment has a RLₘᵢₙ of −26.84 dB at 14.42 GHz, and an effective absorbing bandwidth of 5.8 GHz with RL≤−10 dB within 2-18 GHz.

### Comparative Example 4

This embodiment is the same as Example 1, except that each of the 6×6 carbon fiber felt structure units has an outer-ring width L₁ of 21 mm and an inner-ring width L₂ of 8 mm.

Referring to FIG. 4f, the resin matrix composite metamaterial prepared in this embodiment has a RLₘᵢₙ of −22.83 dB at 18 GHz, and an effective absorbing bandwidth of 6.84 GHz with RL≤−10 dB within 2-18 GHz.

### Comparative Example 5

This embodiment is the same as Example 1, except that each of the 6×6 carbon fiber felt structure units has an outer-ring width L₁ of 28 mm and an inner-ring width L₂ of 20 mm.

Referring to FIG. 4g, the resin matrix composite metamaterial prepared in this embodiment has a RLₘᵢₙ of −16.12 dB at 18 GHz, and an effective absorbing bandwidth of 5.94 GHz with RL≤−10 dB within 2-18 GHz.

Referring to FIGS. 4a-4g, in comparison with Comparative examples 1-5, absorbing bandwidths of the resin matrix composite metamaterials prepared in Examples 1-2 is significantly increased by 42.7%-212.7%.

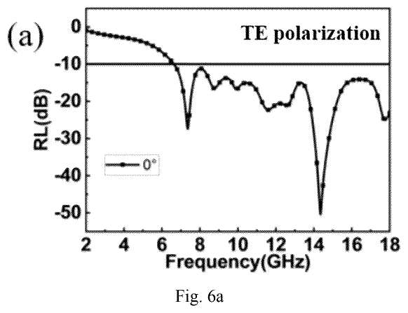

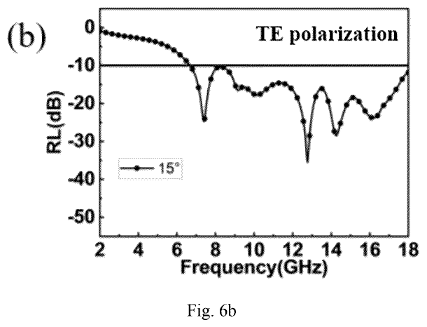

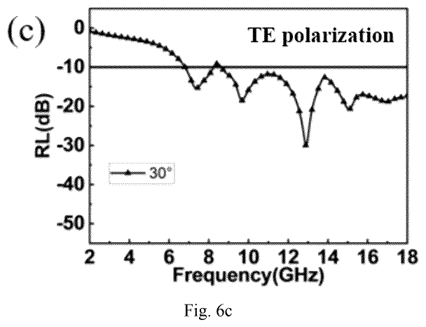

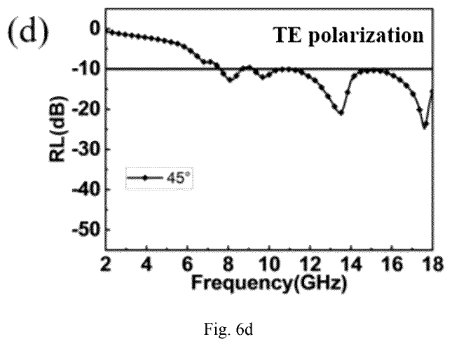

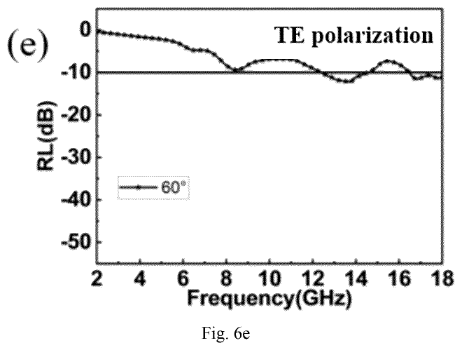

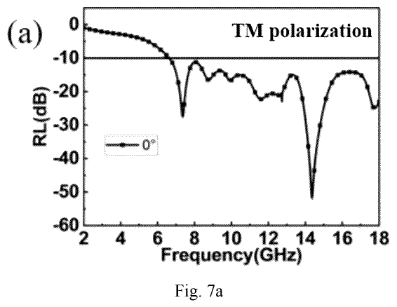

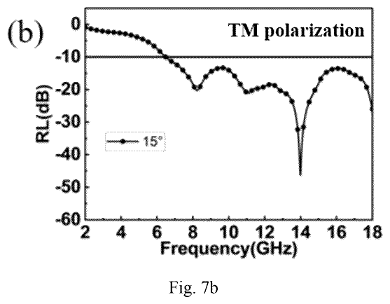

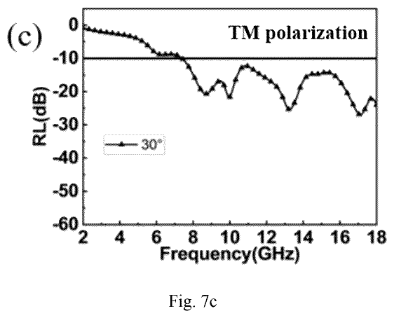

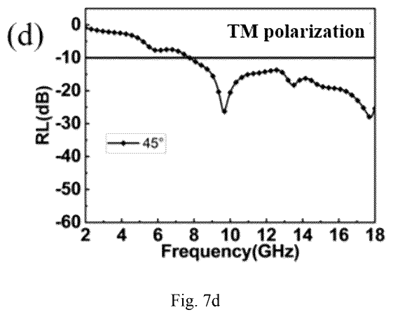

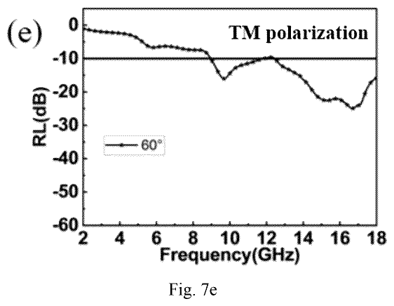

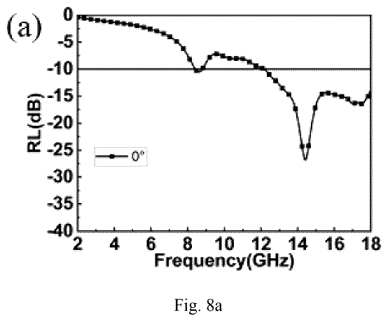

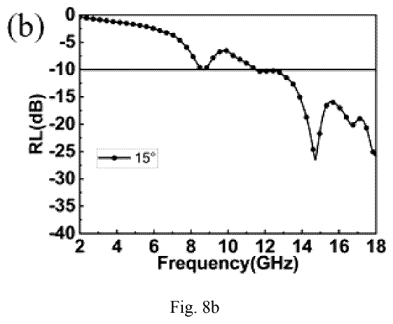

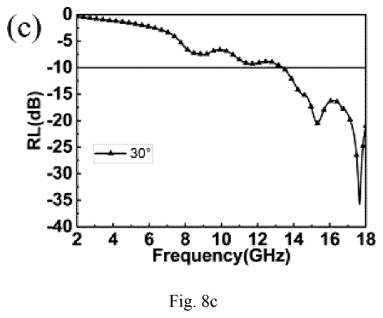

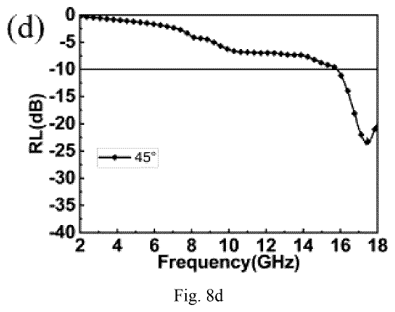

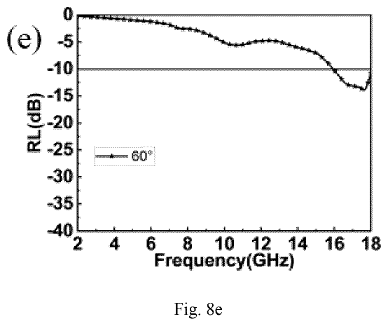

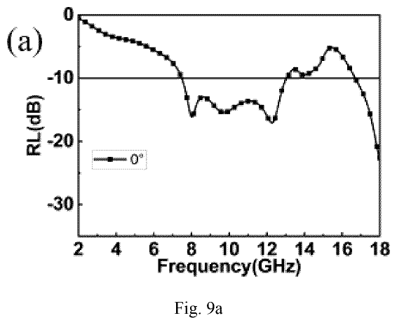

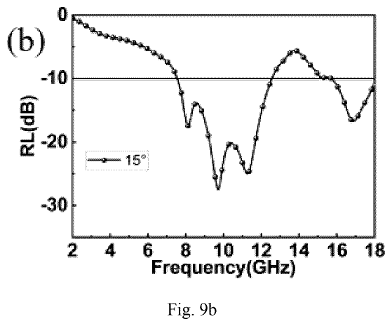

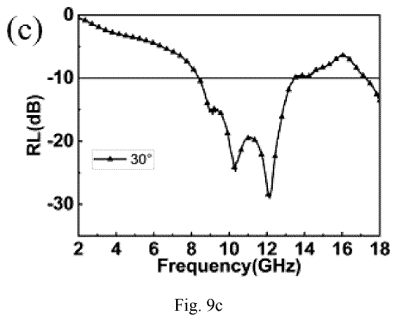

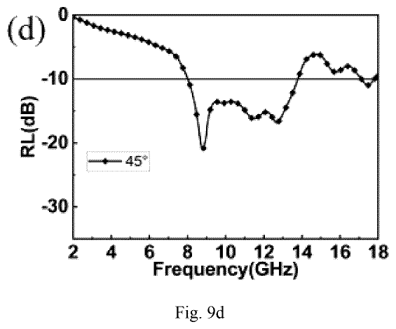

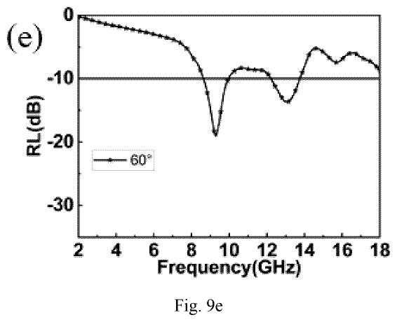

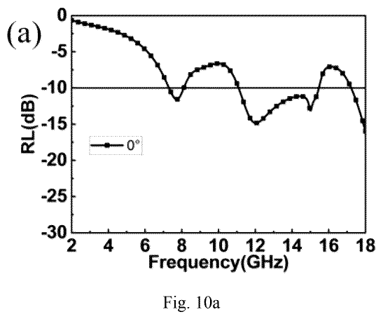

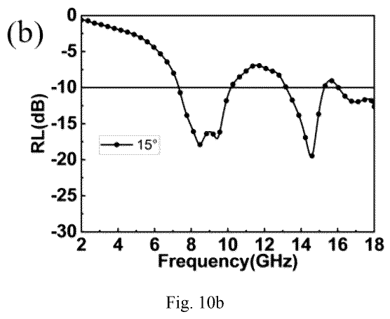

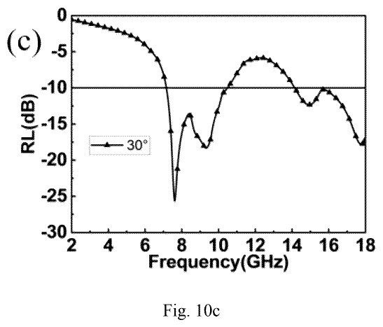

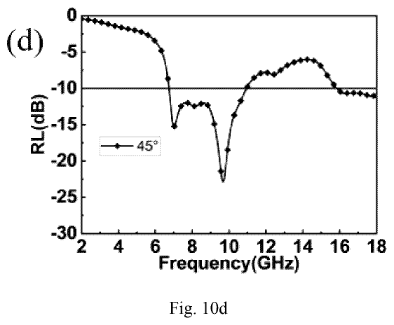

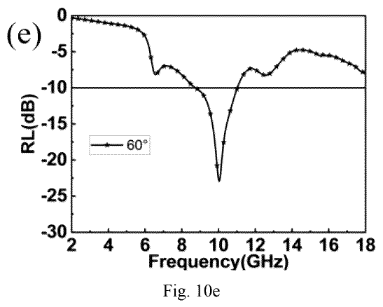

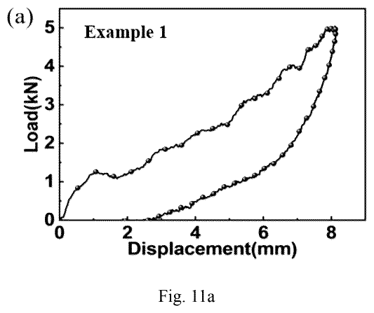

Referring to FIGS. 6a-6e, 8a-8e, 9a-9e, and 10a-10e, in comparison with Comparative examples 3-5, the resin matrix composite metamaterial prepared in Example 1 has more stable wave-absorption performance when the incidence angle rises from 0° to 45° in TE polarization. In addition, referring to FIGS. 7a-7e, in TM polarization, when the incidence angle rises from 0° to 60°, the resin matrix composite metamaterial prepared in Example 1 has maintained wave absorption performance and good angle stability, showing that the resin matrix composite metamaterial of the present disclosure has good polarization stability and angle insensitivity. Because the carbon fiber felt structure units has a symmetric structure and miniaturization characteristics, oblique incident responses of the resin matrix composite metamaterial of the present disclosure can reach 45° in TE polarization and 60° in TM polarization, respectively.

### Comparative Example 6

This embodiment is the same as Example 1, except that no array structure layer is provided.

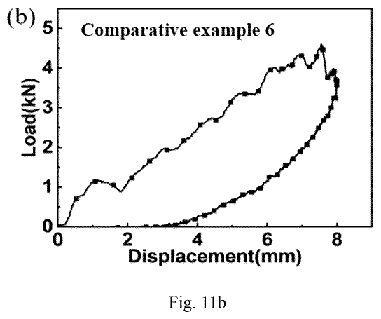

Referring to load-displacement curves in FIGS. 11a-b, when an impact energy is 20 J, an ability to resist a maximum impact load of the resin matrix composite metamaterial prepared in Example 1 is better than that of the composite prepared in Comparative example 6, indicating that the introduction of the array structure layer based on the carbon fiber felt will not affect the impact resistance performance of the composite material.

Described above are specific embodiments of the present disclosure, which are intended to enable those of ordinary skill in the art to understand or implement the present disclosure, rather than limiting the disclosure. Although the disclosure has been are described in detail with reference to the above embodiments, it should be understood by those of ordinary skill in the art that modifications and equivalent replacements can still be made to some or all of the technical features recited in the above embodiments. Such modifications and replacements made without departing from the scope of the present disclosure shall fall within the scope of this application defined by the appended claims.

What is claimed is:

1. A resin matrix composite metamaterial with impact resistance and wave absorption based on a chopped carbon fiber felt, comprising:
a first dielectric layer;
an array structure layer;
a second dielectric layer; and
a reflection layer;
wherein the first dielectric layer, the array structure layer, the second dielectric layer and the reflection layer are laminated in sequence from top to bottom;
the first dielectric layer, the second dielectric layer and the reflection layer are the same as the array structure layer in terms of length and width;
the array structure layer has a centro-symmetric structure, and is composed of m×n carbon fiber felt structure units in a periodic arrangement, wherein m and n are each an integer equal to or larger than 4; the chopped carbon fiber felt of the m×n carbon fiber felt structure units has an electrical resistivity of 0.1-0.2 Ω·cm, an electrical conductivity of 5-10 S/cm, and a sheet resistance of 3-35 Ω/sq; each of the m×n carbon fiber felt structure units is a square-ring patch having an outer-ring width L₁ of 23-26 mm, an inner-ring width L₂ of 10-15 mm, and a periodic side length P of 30 mm;
the first dielectric layer is made of a first fiber fabric-reinforced resin matrix composite; the second dielectric layer is made of a second fiber fabric-reinforced resin matrix composite; and the reflection layer is made of a third fiber fabric-reinforced resin matrix composite; and
the resin matrix composite metamaterial is prepared through steps of:
(S1) designing a structure of the resin matrix composite metamaterial, wherein the structure of the resin matrix composite metamaterial comprises the first dielectric layer, the array structure layer, the second dielectric layer, and the reflection layer from top to bottom;
(S2) according to a designed structure of the array structure layer, cutting the chopped carbon fiber felt into m×n square-ring patches with a designed size;
(S3) according to a length and a width of the designed structure of the array structure layer, cutting a plurality of first fiber fabrics for the first dielectric layer;
(S4) according to the length and the width of the designed structure of the array structure layer, cutting a plurality of second fiber fabrics for the second dielectric layer;
(S5) according to the length and the width of the designed structure of the array structure layer, cutting a plurality of third fiber fabrics for the reflection layer; and
(S6) mixing an epoxy resin and a curing agent to obtain a resin adhesive;
cleaning a mold and applying a mold release agent onto the mold;
successively laying the plurality of third fiber fabrics in a stacked manner on a lower mold plate of the mold, and applying the resin adhesive on each of the plurality of third fiber fabrics to obtain the reflection layer with a designed thickness;
successively laying the plurality of second fiber fabrics in a stacked manner on the reflection layer, and applying the resin adhesive on each of the plurality of second fiber fabrics to form the second dielectric layer with a designed thickness;
successively placing the m×n square-ring patches on the second dielectric layer according to the structure of the array structure layer to form the array structure layer;
successively laying the plurality of first fiber fabrics in a stacked manner on the array structure layer, and applying the resin adhesive on each of the plurality of first fiber fabrics except the last one to form the first dielectric layer with a designed thickness; and
closing the mold, and transferring the mold to a pressing machine for heat-press molding to obtain the resin matrix composite metamaterial.

2. The resin matrix composite metamaterial of claim 1, wherein a first fiber fabric of the first fiber fabric-reinforced resin matrix composite is selected from the group consisting of an aramid fiber fabric, a glass fiber fabric, an ultra-high molecular weight polyethylene fiber fabric, a quartz fiber fabric, and a combination thereof.

3. The resin matrix composite metamaterial of claim 1, wherein a second fiber fabric of the second fiber fabric-reinforced resin matrix composite is selected from the group consisting of an aramid fiber fabric, a glass fiber fabric, an ultra-high molecular weight polyethylene fiber fabric, a quartz fiber fabric, and a combination thereof.

4. The resin matrix composite metamaterial of claim 1, wherein a thickness H₁ of the first dielectric layer is 2.5-5 mm; and a thickness H₂ of the second dielectric layer is 2.5-5 mm.

5. The resin matrix composite metamaterial of claim 1, wherein the first fiber fabric-reinforced resin matrix composite has a dielectric constant of 2.9-3.1 and a density of 0.6-1.25 g/cm³.

6. The resin matrix composite metamaterial of claim 1, wherein the second fiber fabric-reinforced resin matrix composite has a dielectric constant of 2.9-3.1 and a density of 0.6-1.25 g/cm³.

7. The resin matrix composite metamaterial of claim 1, wherein a third fiber fabric of the third fiber fabric-reinforced resin matrix composite is a carbon fiber fabric; and
the reflection layer has an electrical conductivity ζ₁ of 10⁴-10⁵ S/m.

8. The resin matrix composite metamaterial of claim 1, wherein the reflection layer has a thickness of 2-3 mm.

9. The resin matrix composite metamaterial of claim 1, wherein a resin matrix of the first fiber fabric-reinforced resin matrix composite, the second fiber fabric-reinforced resin matrix composite, and the third fiber fabric-reinforced resin matrix composite is epoxy resin; and
a curing agent of the first fiber fabric-reinforced resin matrix composite, the second fiber fabric-reinforced resin matrix composite, and the third fiber fabric-reinforced resin matrix composite is an anhydride-based curing agent.

10. The resin matrix composite metamaterial of claim 1, wherein the heat-press molding is performed through steps of:
keeping the mold at 100° C. for 50 min for gelation of the resin matrix; and
heating the mold to 140° C. and curing the resin matrix at 15 MPa for 2 h.
